(19) United States
(12) Patent Application Publication
(10) Pub. No.: US 2025/0209189 A1
(43) Pub. Date: Jun. 26, 2025

(54) METHOD OF PERMISSION MANAGING, READABLE STORAGE MEDIUM, AND ELECTRONIC DEVICE

(71) Applicant: Beijing Volcano Engine Technology Co., Ltd., Beijing (CN)

(72) Inventors: Changhao LI, Beijing (CN); Wei WEI, Beijing (CN)

(21) Appl. No.: 18/954,271

(22) Filed: Nov. 20, 2024

(30) Foreign Application Priority Data
Dec. 21, 2023 (CN) 202311778476.3

(51) Int. Cl. G06F 21/60

(52) U.S. Cl. CPC G06F 21/604; G06F 2221/2113

(57) ABSTRACT

A method of permission managing, a readable storage medium, and an electronic device are provided. The method includes: obtaining permission data of a plurality of accounts; clustering the plurality of accounts based on the permission data of the plurality of accounts; and generating permission configuration information of at least one account category based on a clustering result of the plurality of accounts.

### CROSS-REFERENCE TO RELATED APPLICATION

The present disclosure claims priority of the Chinese Patent Application No. 202311778476.3 filed on Dec. 21, 2023, the disclosure of which is incorporated herein by reference in its entirety as part of the present application.

### TECHNICAL FIELD

The present disclosure relates to a method of permission managing, a readable storage medium, and an electronic device.

### BACKGROUND

Permission management generally refers to management of an access capability or an access rule of different users to predetermined resources according to a security rule or a security policy set by a service system. Generally, a user can access and can only access a resource authorized to the user in a specific manner (for example, read, write, or delete). In addition, permission management is an important issue for developers of service systems. Any multi-user service system inevitably involves a permission management issue. The more users of the service system, and the more complex the attributes or the division of labor of the users, the more complex the permission management issue. The permission management technology is developed in a trend of multilevel and multi-dimensional. Therefore, how to effectively manage permissions of a service system is crucial to ensure security of the service system.

### SUMMARY

The Summary is to introduce a selection of concepts in a simplified form that are further described below in the Detailed Description. The Summary is not intended to identify key features or essential features of the claimed subject matter, nor is it intended to be used to limit the scope of the claimed subject matter.

The present disclosure provides a method of permission managing, including:
obtaining permission data of a plurality of accounts in a service system;
clustering the plurality of accounts based on the permission data of the plurality of accounts; and
generating permission configuration information of at least one account category for the service system based on a clustering result of the plurality of accounts.

The present disclosure provides an apparatus of permission managing, including:
an obtaining module configured to obtain permission data of a plurality of accounts in a service system;
a first clustering module configured to cluster the plurality of accounts based on the permission data of the plurality of accounts; and
a first generation module configured to generate permission configuration information of at least one account category for the service system based on a clustering result of the plurality of accounts.

The present disclosure provides a non-transitory computer-readable storage medium having a computer program stored thereon, wherein when the program is executed by a processing apparatus, the method of permission managing according to the above is implemented.

The present disclosure provides an electronic device, including:
a storage apparatus having a computer program stored thereon; and
a processing apparatus configured to execute the computer program in the storage apparatus to implement the method of permission managing according to the above of the present disclosure.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the drawings are schematic and that parts and elements are not necessarily drawn to scale. In the drawings:

FIG. 1 is a flowchart of a method of permission managing according to an exemplary embodiment;

FIG. 2 is a schematic diagram of a simplified permission graph according to an exemplary embodiment;

FIG. 3 is a schematic diagram of an architecture of permission processing according to an exemplary embodiment;

FIG. 4 is a schematic diagram of an architecture of data collection and processing according to an exemplary embodiment;

FIG. 5 is a schematic diagram of permission merging according to an exemplary embodiment;

FIG. 6 is a block diagram of an apparatus of permission managing according to an exemplary embodiment; and

FIG. 7 is a schematic structural diagram of an electronic device according to an exemplary embodiment.

### DETAILED DESCRIPTION

Before specific embodiments of the present disclosure are described, nouns involved in the present disclosure are first described.

Kubernetes (abbreviated as K8s) is an open-source container orchestration system, and is intended to automate, scale, and manage deployment and running of containerized applications. With Kubernetes, developers and system administrators can easily deploy, manage, and scale applications running in containers, without having to worry about an underlying infrastructure. Kubernetes provides a declarative configuration manner, and allows a user to define an expected state of an application, and the system automatically ensures that the application reaches and remains in the state.

Role-Based Access Control (RBAC) is a permission control mechanism in Kubernetes. It allows an administrator to control who can access which resources in an application programming interface (API) of Kubernetes by defining “roles” (Roles) and “role bindings” (Role Bindings). In RBAC, a role contains a set of permissions (such as permission to read, write, and delete resources), and a role binding assigns the role to a specific user or a group of users. With RBAC, an administrator can control access permission of users to a Kubernetes cluster in a very fine manner, thereby protecting security of the cluster and ensuring compliance.

Kubernetes log analysis is an important function in a Kubernetes system, and provides an ability to record and save cluster activities. With log analysis, a system administrator and a security expert can trace back events that occur in the cluster, to ensure security of the system. In Kubernetes log analysis, a log analysis system captures each request that occurs on the cluster, and records the request in a log. Each log entry contains detailed information about the request, such as an identity of a requester, a time of the request, an operation performed, a resource affected, and a result of the request. A Kubernetes log analysis function works by defining a log analysis policy, and an administrator may configure the log analysis policy as needed, to determine which types of requests should be recorded and how much detailed information should be recorded. In this way, the administrator may customize a log analysis configuration based on security requirements of the administrator.

Permission modeling is a method of creating and optimizing permission configuration by analyzing behaviors and permission requirements of users or roles in a system. This method is particularly suitable for a complex system and environment, which contain a large number of users and different levels of permission settings. Through permission modeling, permission requirements of users and the system can be better understood, thereby implementing finer and more secure permission control.

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifiers such as “one” and “a plurality of” mentioned in the present disclosure are illustrative and not restrictive, and persons skilled in the art should understand that the modifiers should be understood as “one or more” unless the context clearly indicates otherwise.

Names of messages or information exchanged between a plurality of apparatuses in the implementations of the present disclosure are used for illustrative purposes only, and are not used to limit the scope of these messages or information.

Data involved in the technical solution herein (including but not limited to data itself, data obtaining, use, storage, or deletion) shall comply with requirements of corresponding laws, regulations, and relevant provisions.

It may be understood that before the technical solution disclosed in each embodiment of the present disclosure is used, the type, a scope of use, a use scenario, and the like of information involved in the present disclosure shall be informed to a related user and authorized by the related user by an appropriate manner in accordance with related laws and regulations, wherein the related user may include any type of right subject, for example, an individual, an enterprise, or a group.

For example, when receiving an active request from a user, a prompt message is sent to the user, to explicitly prompt the user that an operation requested by the user will need to obtain and use personal information of the user. Therefore, the user can choose whether to provide the personal information to a software or hardware such as an electronic device, an application, a server, or a storage medium that executes the operation of the technical solution of the present disclosure based on the prompt message.

As an optional but non-limiting implementation, the manner of sending the prompt message to the user in response to receiving the active request from the user may be, for example, a pop-up window, and the prompt message may be presented in the pop-up window in text. In addition, the pop-up window may also carry a selection control for the user to select “Agree” or “Disagree” to provide the personal information to the electronic device.

It may be understood that the above notification and user authorization obtaining process is only illustrative, and does not constitute a limitation on the implementation of the present disclosure. Other manners that meet related laws and regulations may also be applied to the implementation of the present disclosure.

Meanwhile, it may be understood that data involved in the technical solution herein (including but not limited to the data itself, or obtaining or use of the data) shall comply with requirements of corresponding laws, regulations, and related provisions.

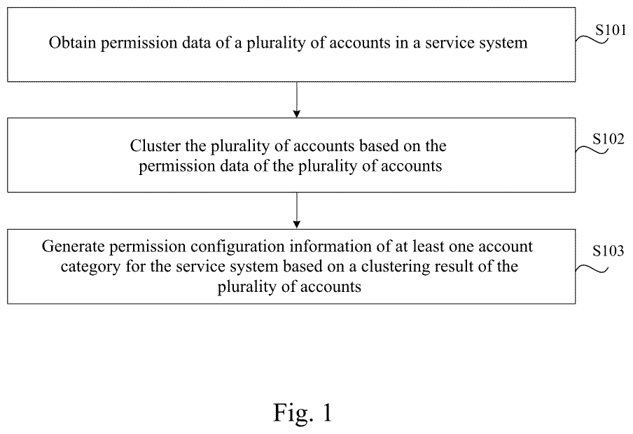

FIG. 1 is a flowchart of a method of permission managing according to an exemplary embodiment. As shown in the figure, the method of permission managing may include S101 to S103.

In S101, Obtain permission data of a plurality of accounts in a service system.

In the present disclosure, the accounts are existing accounts in the service system, the plurality of accounts may include all the existing accounts in the service system, or may include some of the existing accounts in the service system. The service system may be, for example, the above Kubernetes (K8s) system, the above method of permission managing is a role-based access control (RBAC)-based permission management mechanism, and the system may include a plurality of K8s clusters.

The permission data may include, but is not limited to, an account name (Account), an accessed namespace (Namespace), an accessed API group (APIGroup), an accessed resource (Resource), an operation (Verb) on the resource, and the like of a corresponding account, which form a set of structured data.

In S102, Cluster the plurality of accounts based on the permission data of the plurality of accounts.

In S103, Generate permission configuration information of at least one account category for the service system based on a clustering result of the plurality of accounts.

In the present disclosure, the clustering result of the plurality of accounts may include at least one account category, and each of the at least one account category includes at least one of the accounts. The plurality of accounts may belong to one account category, in which case the clustering result of the plurality of accounts includes one account category, the plurality of accounts may belong to different account categories, in which case the clustering result of the plurality of accounts includes a plurality of account categories.

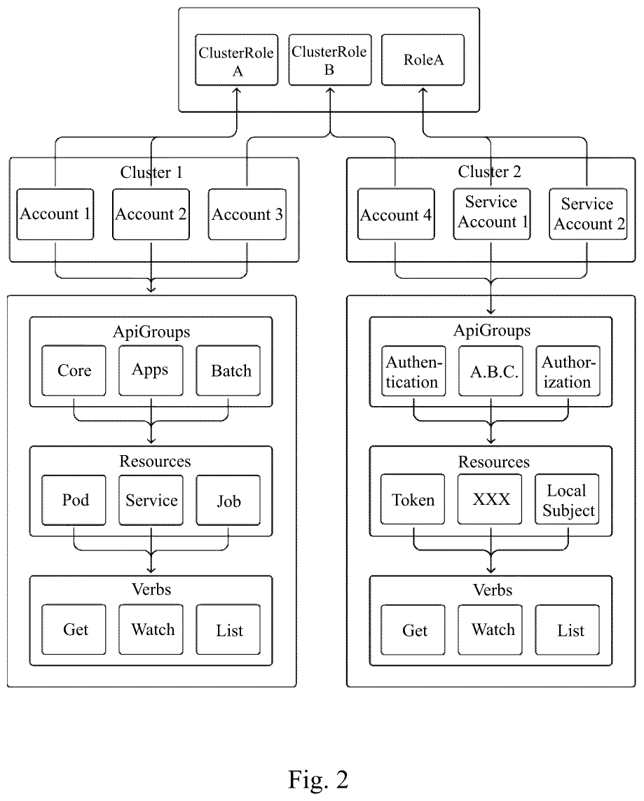

When the plurality of accounts are clustered, accounts with highly similar access permissions may be divided into one account category. As shown in FIG. 2, FIG. 2 shows different roles, accounts, service accounts in K8s cluster and a complex permission relationship between they and a cluster, an API group, a resource, and an operation. The figure simplifies the complex permission relationship. After the plurality of accounts are clustered, it is found that there is a high similarity in access permissions of Account1, Account2, and Account3, and therefore they are divided into one account category, that is, Cluster 1. Similarly, other accounts are clustered to obtain a clustering result. As shown in FIG. 2, by clustering Account1, Account2, Account3, Account4, Service Account1, and Service Account2, two account categories, that is, Cluster 1 and Cluster 2, may be obtained, where Account1, Account2, and Account3 belong to Cluster 1, and Account4, Service Account1, and Service Account2 belong to Cluster 2.

According to the above technical solution, after the permission data of the plurality of accounts in the service system is obtained, the plurality of accounts are clustered based on the permission data of the plurality of accounts, and the permission configuration information of the at least one account category for the service system is generated based on the clustering result of the plurality of accounts, so that a permission structure can be described clearly and concisely, and permission requirements of users and a system can be better understood, thereby implementing finer and more secure permission control. Through the generated permission configuration information, a system administrator can clearly know permission distribution of each account, thereby quickly discovering and handling redundant and excessive permissions, so that permission management is finer, which not only brings great convenience to the system administrator, but also greatly improves security and efficiency of a service system.

A specific implementation of obtaining permission data of a plurality of accounts in a service system in S101 is described in detail below. Specifically, the implementation may be implemented in a plurality of implementations. In an implementation, the above service system may include a large number of clusters, and for collection and processing of a large amount of log data generated by hundreds of clusters, the present disclosure uses an efficient solution that comprehensively uses distributed processing, multi-level caching, and a synchronization mechanism. A multi-level caching architecture is used to optimize efficiency of collection and processing of log data. In such an architecture, caches at different levels are designed to process different data, to ensure efficient running of the system. Generally, a large amount of log data is generated, and a large amount of duplicate data exists at the same time. Therefore, the present disclosure customizes a specific cache levels based on characteristics and processing requirements of the log data. Each cache level is optimized for different data processing stages and characteristics of the log data. Specifically, the permission data of the plurality of accounts in the service system may be obtained through the following steps (1) and (2).
Step (1): Obtain target resource access records of the plurality of accounts in the service system from a first buffer.

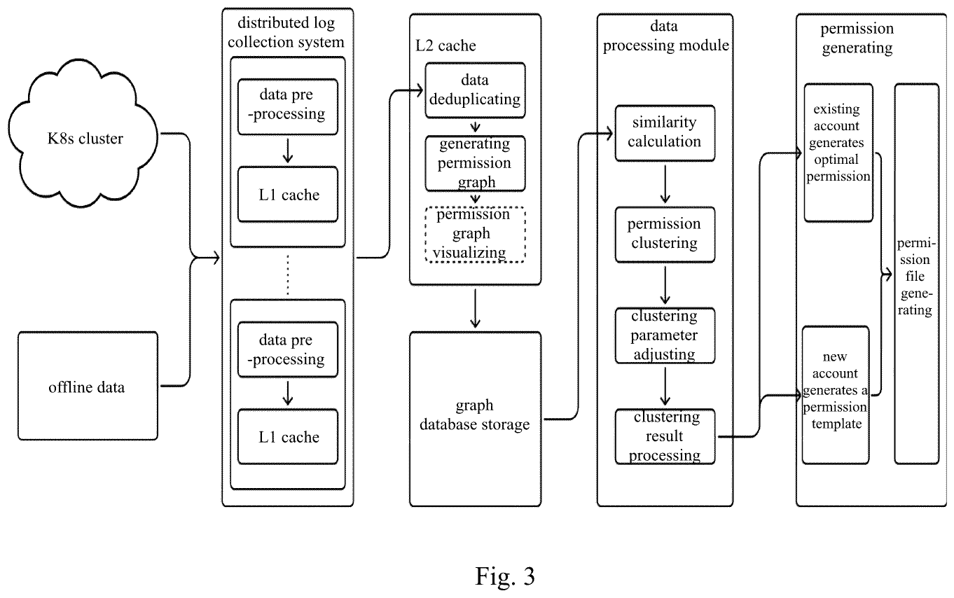

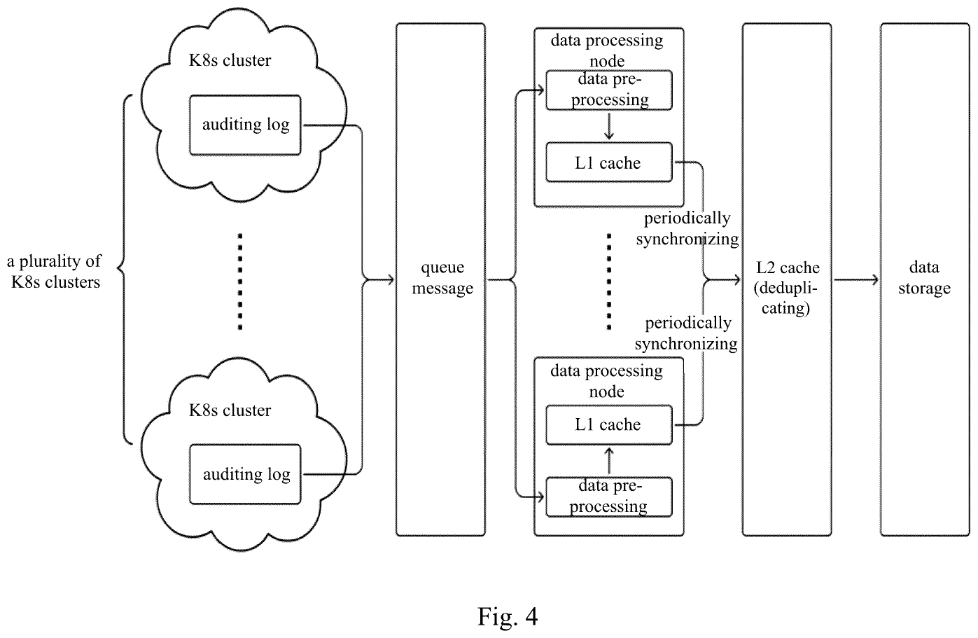

In the present disclosure, the above permission processing method may be applied to an electronic device. As shown in FIG. 3 and FIG. 4, the electronic device may collect and process log data through a distributed log collection system, where the distributed log system includes a plurality of distributed clients (that is, data processing nodes in FIG. 4). Specifically, log data of the service system is synchronously collected by the plurality of distributed clients, the plurality of distributed clients respectively extract the target resource access records of the accounts from the log data collected by the distributed clients and store the target resource access records in local buffers (that is, L1 caches in FIG. 3 and FIG. 4), and the target resource access records in the local buffers are synchronized to the first buffer (that is, an L2 cache in FIG. 3 and FIG. 4) periodically. The respective local buffers and the first buffer form a multi-level cache.

The distributed clients are used to collect the log data, and each distributed client is responsible for collecting corresponding log data, so that a large amount of data is processed in parallel, thereby improving efficiency of data collection and processing, and ensuring that the log data can be efficiently collected and processed in a multi-cluster environment, which can not only quickly process a large amount of log data, but also ensure accuracy of recorded permission access information. This provides a solid foundation for subsequent data analysis and permission management.
Step (2): Generate, for each of the accounts, permission data of the account, based on the target resource access record of the account.

In the present disclosure, one target resource access record may be extracted from one piece of log data corresponding to an account, where the target resource access record includes information such as an access condition of the account to a resource and an operation performed on the resource, and includes but is not limited to an account name (Account), an accessed namespace (Namespace), an accessed API group (APIGroup), an accessed resource (Resource), an operation (Verb) on the resource, and the like of a corresponding account, which form one piece of structured data. One account may include a plurality of target resource access records, and the plurality of target resource access records include different resource access information. In this case, the resource access information involved in the plurality of target resource access records may be integrated to obtain permission data of the account.

As shown in FIG. 3 and FIG. 4, the plurality of distributed clients collect the log data of the service system in parallel. After collecting the log data, each distributed client performs data preprocessing on the collected log data to obtain a target resource access record of a corresponding account, and then stores the target resource access record in a local buffer (that is, an L1 cache) of the distributed client. Data in the local buffers of the distributed clients is synchronized to the first buffer (that is, an L2 cache) periodically. In this way, the electronic device may asynchronously obtain the target resource access records of the plurality of accounts in the service system from the first buffer, and then generate permission data of each account based on the target resource access records. The first buffer may be a buffer area provided on the above electronic device or may be a buffer area provided on another device or a cloud.

The above synchronization mechanism may include data synchronization and state synchronization. The data synchronization refers to that the target resource access record is synchronized from an upstream local buffer to a downstream first buffer periodically, and the electronic device may asynchronously obtain data from the first buffer, so as to implement an asynchronous synchronization mechanism. In this way, complete data transmission can be ensured without affecting the real-time performance of the system. The state synchronization refers to maintaining unified state information (that is, permission-related information of the plurality of accounts) between the multi-level caches to track a progress and a state of data processing.

To avoid a problem that a distributed log collection system cannot be processed in time due to a sudden increase of system log data, a second buffer may be additionally provided to store the log data of the above service system, that is, the log data is stored in the second buffer, so that the plurality of distributed clients respectively collect the log data from the second buffer. The log data in the second buffer may be stored in a form of a queue.

In addition, the distributed client extracts the target resource access records of the accounts from the log data through the following steps (11) to (14) (that is, data preprocessing in FIG. 3 and FIG. 4):
Step (11): Extract original resource access records of each account from the log data.

In the present disclosure, one original resource access record may be extracted from one piece of log data corresponding to an account, where the original resource access record includes information such as an access condition of the account to a resource and an operation performed on the resource, and includes but is not limited to an account name (Account), an accessed namespace (Namespace), an accessed API group (APIGroup), an accessed resource (Resource), an operation (Verb) on the resource, and the like of a corresponding account, which form one piece of unstructured data.
Step (12): Perform, for each of the original resource access records, structuring on the original resource access record.

The collected original resource access records are arranged into a structured format, which facilitates subsequent data processing and analysis.
Step (13): Perform standardization processing on a resource access record obtained after structuring

In different original resource access records, the same attribute may be represented by different forms or parameters. To facilitate subsequent permission analysis and management, the standardization processing may be performed on the resource access record obtained after structuring. The standardization processing refers to standardizing various attributes (such as a permission level, a resource type, an operation type, and the like) of a permission entity (that is, an account) and a relationship to ensure data consistency.
Step (14): Perform deduplication processing on the resource access records obtained after standardization processing to obtain the target resource access records of the plurality of accounts.

An account may access a same resource for a plurality of times. Therefore, there may be a plurality of duplicate original resource access records for one account. Correspondingly, the resource access records obtained after standardization processing may have duplicate records. Therefore, the resource access records obtained after standardization processing may be performed with deduplication processing.

In addition to collecting and processing the log data with the aid of the distributed log collection, the electronic device may also collect and process the log data locally. Specifically, in another implementation, the above electronic device may directly collect the log data of the service system, then extract the target resource access records of each account from the collected log data, and finally, for each of each account, generate the permission data of the account based on the target resource access record of the account. The electronic device may extract the target resource access records of each account from the collected log data in a manner similar to that in which the distributed client extracts the target resource access records of each account from the log data, which will not be described in the present disclosure again.

To meet requirements for more data sources, when the original resource access records are obtained, in addition to the log data, as shown in FIG. 3, data sources may further include offline data, that is, the original resource access records of each account are extracted from both the offline data and the log data.

A specific implementation of clustering the plurality of accounts based on the permission data of the plurality of accounts in S102 is described in detail below. Specifically, the implementation may be implemented through the following steps [1] and [2].
Step [1]: For each of the plurality of accounts, generate a permission graph corresponding to the account based on the permission data of the account.

In the present disclosure, in the permission graph, different types of nodes are defined to respectively represent an account name (Account), a namespace (Namespace), an API group (APIGroup), a resource (Resource), and an operation (Verb). If an account has permission to access a namespace, there is an edge relationship between an account name node of the account and a namespace node that the account can access. If an account has permission to access an API group, there is an edge relationship between an account name node of the account and an API group node that the account can access. If an account has permission to access some resources of an API group, there is an edge relationship between an API group node that the account can access and a resource node that the account can access. If an account has permission to perform some operations on a resource, there is an edge relationship between a resource node that the account can access and an operation node on the resource.
Step [2]: Cluster the plurality of accounts based on the permission graphs respectively corresponding to the plurality of accounts.

After the permission data of the plurality of accounts in the service system is obtained, for each account, a permission graph corresponding to the account is generated based on the permission data of the account, so that a complex permission structure can be successfully simplified and visualized, providing a clear and intuitive visual basis for permission management and subsequent data processing, and making the permission management more intuitive and understandable.

A specific implementation of generating the permission graph corresponding to the account based on the permission data of the account in the above step [1] is described in detail below.

In an implementation, the account name, the namespace, the API group, the resource, the operation, and the like in the permission data of the account may be used as nodes, and then an edge relationship between the nodes is constructed based on permission of the account to the namespace, the API group, the resource, and the operation. Specifically, if an account has permission to access a namespace, an edge relationship is established between an account name node of the account and a namespace node. If an account has permission to access an API group, an edge relationship is established between an account name node of the account and an API group node. If an account has permission to access some resources of an API group, an edge relationship is established between an API group node that the account can access and a resource node that the account can access. If an account has permission to perform some operations on a resource, an edge relationship is established between a resource node that the account can access and an operation node on the resource.

In addition, to improve readability and understandability of the permission graph, after the permission graph is generated, a hierarchical layout algorithm may be used to optimize arrangement of nodes in the permission graph.

As shown in FIG. 4, after the permission graph is generated, data storage may be performed on the permission graph. As shown in FIG. 3, the permission graphs of the accounts may be stored in a graph database, so that a permission graph corresponding to a specified account can be visually displayed by using a visualization tool subsequently.

A specific implementation of clustering the plurality of accounts based on the permission graphs respectively corresponding to the plurality of accounts in the above step [2] is described in detail below. Specifically, the implementation may be implemented through the following steps (a1) and (a2).
Step (a1): Determine, based on the permission graphs respectively corresponding to the plurality of accounts, a similarity between every two accounts in the plurality of accounts.

As shown in FIG. 3, after the permission graphs corresponding to the plurality of accounts are obtained, a data processing module in the above electronic device may be used to calculate a similarity between the permission graphs and perform permission clustering. Specifically, a feature vector of the permission graph corresponding to each of the plurality of accounts may be determined. Then, for every two accounts in the plurality of accounts, a similarity between the feature vectors of the permission graphs respectively corresponding to the two accounts is determined as a similarity between the two accounts.

For example, a similarity between the feature vectors of the permission graphs respectively corresponding to the two accounts may be measured based on a cosine distance, a Euclidean distance, or the like.
Step (a2): Cluster the plurality of accounts based on all the similarities.

In the present disclosure, the plurality of accounts may be clustered by using a corresponding clustering algorithm based on characteristics and requirements of the permission data.

For example, the above service system is Kubernetes (K8s). To ensure that a structure and characteristics of K8s RBAC permission data can be accurately reflected, a density-based spatial clustering of applications with noise (DBSCAN) algorithm may be used to cluster the plurality of accounts. As shown in FIG. 3, during clustering by using DBSCAN, clustering parameters of DBSCAN may be dynamically adjusted by using a manner such as a silhouette coefficient or a Davies-Bouldin index, to evaluate a clustering effect and precision.

A specific implementation of determining the feature vector of the permission graph corresponding to the account is described in detail below. Specifically, the implementation may be implemented in a plurality of implementations. In an implementation, the feature vector of the permission graph corresponding to the account may be generated based on a connection relationship between nodes and attribute information of each node in the permission graph corresponding to the account.

In another implementation, the feature vector of the permission graph corresponding to each account may be generated by using a pre-trained feature extraction model. Specifically, for each account, a permission graph of the account may be input into the feature extraction model to obtain a feature vector of the permission graph corresponding to the account. In this way, the feature vector of the permission graph corresponding to the account can be quickly obtained through the feature extraction model, which is convenient and fast.

In an implementation, the above feature extraction model may be a deep learning-based autoencoder. The autoencoder is used to process permission information of K8s to generate a feature vector, and the feature vector can effectively represent the permission data.

A specific implementation of generating permission configuration information of at least one account category for the service system based on the clustering result of the plurality of accounts in S103 is described in detail below. As shown in FIG. 3, after the clustering result is obtained, the clustering result may be further processed to perform permission configuration information modeling. Specifically, for each account category, permission data of each account in the account category may be combined to obtain permission configuration information of the account category.

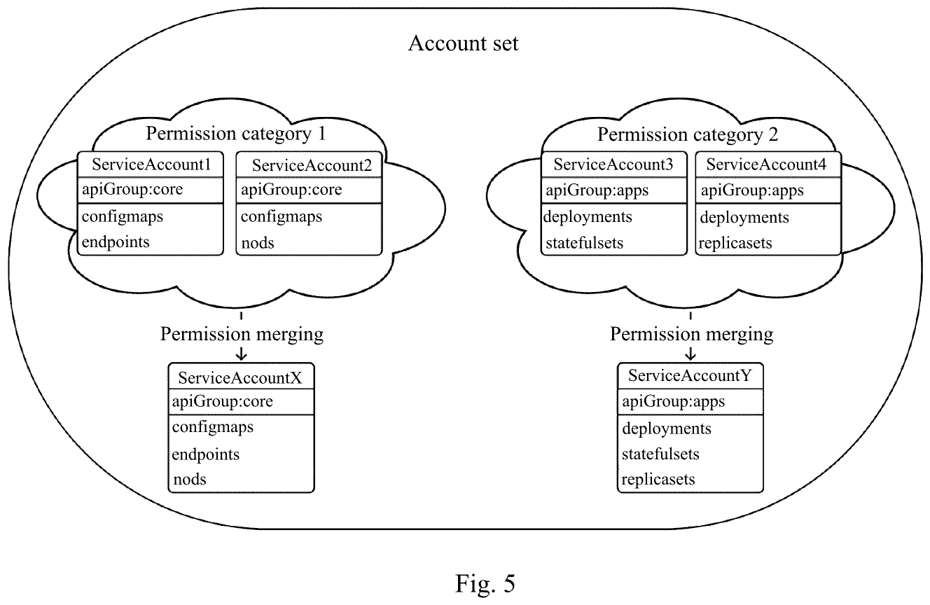

For example, as shown in FIG. 5, the plurality of accounts are aggregated to obtain two account categories (that is, permission category 1 and permission category 2). The permission category 1 includes two accounts, namely ServiceAccount1 and ServiceAccount2 (two account names), and the permission category 2 also includes two accounts, namely ServiceAccount3 and ServiceAccount4. After permission merging (that is, combining) of permission data of ServiceAccount1 and data of ServiceAccount2 in the permission category 1, a permission merging result shown in the lower right corner of FIG. 5 may be obtained, to obtain permission configuration information of the permission category 1 (that is, permission configuration information of ServiceAccountX in FIG. 5). After permission merging (that is, combining) of permission data of ServiceAccount3 and data of ServiceAccount4 in the permission category 2, a permission merging result shown in the upper left corner of FIG. 4 may be obtained, to obtain permission configuration information of the permission category 2 (that is, permission configuration information of ServiceAccountY in FIG. 5).

As another example, permission data of Cluster 1 is specifically an API group and downstream nodes thereof that are shown in FIG. 2 and respectively connected to each account (including Account1, Account2, and Account3) in Cluster 1, and permission data of Cluster 2 is specifically an API group and downstream nodes thereof that are shown in FIG. 2 and respectively connected to each account (including Account4, Service Account1, and Service Account2) in Cluster 2.

To facilitate quick obtaining of permission information of an account, as shown in FIG. 3, a corresponding permission file may be pre-generated for each account as an optimal permission that the account should use, so that a risk of the existing account can be mitigated. Specifically, the above method may further include the following steps:
for each account, determining a target type of a permission file corresponding to the account based on a namespace access condition of the account; and
generating, based on the permission configuration information of the account category to which the account belongs and the target type, the permission file corresponding to the account.

In the present disclosure, if a permission graph corresponding to the account includes a plurality of namespaces, it indicates that the account has namespace access permission at a cluster level, and in this case, it may be determined that a target type of the permission file corresponding to the account is a cluster role (ClusterRole). If the permission graph corresponding to the account includes one namespace, it indicates that the account has single namespace access permission, and in this case, it may be determined that the target type of the permission file corresponding to the account is a role (Role).

For example, as shown in FIG. 2, a permission file of ClusterRoleA is generated for Account1 and Account2; a permission file of ClusterRoleB is generated for Account3 and Account4; and a permission file of Role is generated for Service Account1 and Service Account2.

In addition, in order to simplify a permission management process to improve security and efficiency of a system, a permission configuration template may be pre-generated according to cluster present situation, based on permission optimization of accounts, and a new account may create a permission resource based on the template, thereby simplifying a permission configuration process of the new account. Specifically, the above method may further include the following steps:
for each of a plurality of preset permissions, screening, from the plurality of accounts based on the permission data of the plurality of accounts, a plurality of target accounts having the preset permission;
clustering the plurality of target accounts based on the permission data of the plurality of target accounts; and
combining permission data of each target account in a target account category to obtain a permission configuration template corresponding to the preset permission, wherein the target account category is an account category that contains a largest number of the target accounts in a clustering result of the plurality of target accounts.

In the present disclosure, the plurality of preset permissions may be a plurality of most frequently used permissions in a service system, for example, the plurality of preset permissions include read permission, write permission, delete permission, and the like.

In addition, the plurality of target accounts may be clustered based on the permission data of the plurality of target accounts in a manner similar to that in which the plurality of accounts are clustered based on the permission data of the plurality of accounts in S102, which will not be described in the present disclosure again. To ensure that as many accounts as possible have the preset permission, a clustering threshold used for clustering the plurality of target accounts is less than a clustering threshold used for clustering the plurality of accounts.

In addition, to simplify the permission configuration process of the new account, as shown in FIG. 3, the new account may create a permission resource based on a pre-established permission configuration template. Specifically, the above method may further include the following two steps:
in response to detecting a creation request for a new account, determining, from the plurality of preset permissions, a target permission that matches the creation request; and
generating a permission file of the new account based on the permission configuration template corresponding to the target permission.

In the present disclosure, the creation request includes a permission that the new account expects to access, and the target permission that matches the permission request is the permission that the new account expects to access. For example, the plurality of preset permissions include read permission, write permission, and delete permission, and the permission that the new account expects to access is write permission, so the target permission is write permission.

When the permission file of the new account is generated, a type of the permission file of the new account needs to be determined first. The type may be specified by a user when the new account is created.

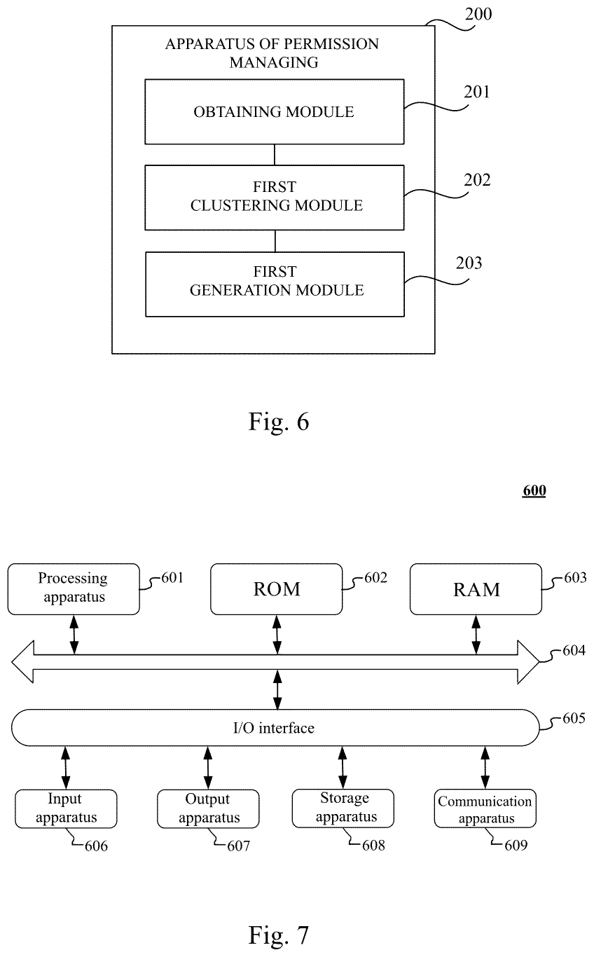

FIG. 6 is a block diagram of an apparatus of permission managing according to an exemplary embodiment. As shown in FIG. 6, an apparatus 200 of permission managing includes:
an obtaining module 201, configured to obtain permission data of a plurality of accounts in a service system;
a first clustering module 202, configured to cluster the plurality of accounts based on the permission data of the plurality of accounts; and
a first generation module 203, configured to generate permission configuration information of at least one account category for the service system based on a clustering result of the plurality of accounts.

According to the above technical solution, after the permission data of the plurality of accounts in the service system is obtained, the plurality of accounts are clustered based on the permission data of the plurality of accounts, and the permission configuration information of the at least one account category for the service system is generated based on the clustering result of the plurality of accounts, so that a permission structure can be described clearly and concisely, and permission requirements of users and a system can be better understood, thereby implementing finer and more secure permission control. Through the generated permission configuration information, a system administrator can clearly know permission distribution of each account, thereby quickly discovering and handling redundant and excessive permissions, so that permission management is finer, which not only brings great convenience to the system administrator, but also greatly improves security and efficiency of a service system.

Optionally, the first clustering module 202 includes:
a first generation sub-module, configured to: for each of the plurality of accounts, generate a permission graph corresponding to the account based on the permission data of the account; and
a first clustering sub-module, configured to cluster the plurality of accounts based on the permission graphs respectively corresponding to the plurality of accounts.

Optionally, the first clustering sub-module includes:
a first determination sub-module, configured to determine, based on the permission graphs respectively corresponding to the plurality of accounts, a similarity between every two accounts in the plurality of accounts; and
a second clustering sub-module, configured to cluster the plurality of accounts based on all the similarities.

Optionally, the first determination sub-module includes:
a second determination sub-module, configured to determine a feature vector of the permission graph respectively corresponding to each of the plurality of accounts; and
a third determination sub-module configured to: for every two accounts in the plurality of accounts, determine a similarity between the feature vectors of the permission graphs respectively corresponding to the two accounts as a similarity between the two accounts.

Optionally, the clustering result of the plurality of accounts includes at least one account category, and each of the at least one account category includes at least one of the accounts.

The first generation module 203 is configured to: for each account category, combine the permission data of each account in the account category to obtain permission configuration information of the account category.

Optionally, the obtaining module 201 includes:
an obtaining sub-module, configured to obtain target resource access records of the plurality of accounts in the service system from a first buffer, wherein log data of the service system is synchronously collected by a plurality of distributed clients, the plurality of distributed clients respectively extract the target resource access records of each account from the log data respectively collected by the distributed clients and store the target resource access records in local buffers, and the target resource access records in the local buffers are synchronized to the first buffer periodically; and
a second generation sub-module configured to: for each of the accounts, generate permission data of the account based on the target resource access record of the account.

Optionally, the log data is stored in a second buffer, and the plurality of distributed clients respectively collect the log data from the second buffer.

Optionally, the distributed client extracts the target resource access records of each account from the log data in the following manner:
extracting original resource access records of each account from the log data;
for each of the original resource access records, performing structuring on the original resource access record; performing standardization processing on a resource access record obtained after structuring; and
performing deduplication processing on the resource access records obtained after standardization processing to obtain the target resource access records of the plurality of accounts.

Optionally, the apparatus 200 further includes:
a first determination module, configured to for each of the accounts, determine a target type of a permission file corresponding to the account based on a namespace access condition of the account; and
a second generation module, configured to generate, based on the permission configuration information of the account category to which the account belongs and the target type, the permission file corresponding to the account.

Optionally, the apparatus 200 further includes:
a screening module, configured to for each of a plurality of preset permissions, screen, from the plurality of accounts based on the permission data of the plurality of accounts, a plurality of target accounts having the preset permission;
a second clustering module, configured to cluster the plurality of target accounts based on the permission data of the plurality of target accounts; and
a combining module, configured to combine permission data of each target account in a target account category to obtain a permission configuration template corresponding to the preset permission. The target account category is an account category that contains a largest number of the target accounts in a clustering result of the plurality of target accounts.

Optionally, the apparatus 200 further includes:
a second determination module, configured to in response to detecting a creation request for a new account, determine, from the plurality of preset permissions, a target permission that matches the creation request; and
a third generation module, configured to generate a permission file of the new account based on the permission configuration template corresponding to the target permission.

The present disclosure further provides a non-transitory computer-readable storage medium having stored thereon a computer program that, when executed by a processing apparatus, causes the above method of permission managing provided in the present disclosure to be implemented.

Reference is made to FIG. 7 below, which is a schematic diagram of a structure of an electronic device (for example, a terminal device or a server) 600 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (for example, a vehicle navigation terminal), and fixed terminals such as a digital TV and a desktop computer. The electronic device shown in FIG. 7 is merely an example and shall not impose any limitation on a function and a scope of use of the embodiments of the present disclosure.

As shown in FIG. 7, the electronic device 600 may include a processing apparatus (for example, a central processor, a graphics processor, and the like) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 7 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate by using any currently known or future-developed network protocol such as a hypertext transfer protocol (HTTP), and may be interconnected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain permission data of a plurality of accounts in a service system; cluster the plurality of accounts based on the permission data of the plurality of accounts; and generate permission configuration information of at least one account category for the service system based on a clustering result of the plurality of accounts.

The computer program code for performing operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user through any type of network, including a local area network (LAN) or a wide area network (WAN), or may be connected to an external computer (for example, connected over the Internet through an Internet service provider).

The flowcharts and block diagrams in the drawings illustrate possible architecture, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in a reverse order, depending on a function involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The name of the module does not constitute a limitation on the module itself in some cases. For example, the obtaining module may also be described as a “module for obtaining permission data of a plurality of accounts in a service system”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on a chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a method of permission managing, including:
obtaining permission data of a plurality of accounts in a service system;
clustering the plurality of accounts based on the permission data of the plurality of accounts; and
generating permission configuration information of at least one account category for the service system based on a clustering result of the plurality of accounts.

According to one or more embodiments of the present disclosure, Example 2 provides the method of Example 1. The clustering the plurality of accounts based on the permission data of the plurality of accounts includes:
for each of the plurality of accounts, generating a permission graph corresponding to the account based on the permission data of the account; and
clustering the plurality of accounts based on the permission graphs respectively corresponding to the plurality of accounts.

According to one or more embodiments of the present disclosure, Example 3 provides the method of Example 2. The clustering the plurality of accounts based on the permission graphs respectively corresponding to the plurality of accounts includes:
determining, based on the permission graphs respectively corresponding to the plurality of accounts, a similarity between every two accounts in the plurality of accounts; and
clustering the plurality of accounts based on all the similarities.

According to one or more embodiments of the present disclosure, Example 4 provides the method of Example 3. The determining, based on the permission graphs respectively corresponding to the plurality of accounts, a similarity between every two accounts in the plurality of accounts includes:
determining a feature vector of the permission graph corresponding to each of the plurality of accounts; and
for every two accounts in the plurality of accounts, determining a similarity between the feature vectors of the permission graphs respectively corresponding to the two accounts as a similarity between the two accounts.

According to one or more embodiments of the present disclosure, Example 5 provides the method of Example 1. The clustering result of the plurality of accounts includes at least one account category, and each of the at least one account category includes at least one of the accounts.

The generating permission configuration information of at least one account category for the service system based on a clustering result of the plurality of accounts includes:
for each of the at least one account category, combining the permission data of the accounts in the account category to obtain permission configuration information of the account category.

According to one or more embodiments of the present disclosure, Example 6 provides the method of Example 1. The obtaining permission data of a plurality of accounts in a service system includes:
obtaining target resource access records of the plurality of accounts in the service system from a first buffer, wherein log data of the service system is synchronously collected by a plurality of distributed clients, the plurality of distributed clients respectively extract the target resource access records of the accounts from the log data respectively collected by the distributed clients and store the target resource access records in local buffers, and the target resource access records in the local buffers are synchronized to the first buffer periodically; and
for each of the accounts, generating permission data of the account based on the target resource access record of the account.

According to one or more embodiments of the present disclosure, Example 7 provides the method of Example 6. The log data is stored in a second buffer, and the plurality of distributed clients respectively collect the log data from the second buffer.

According to one or more embodiments of the present disclosure, Example 8 provides the method of Example 6. The distributed client extracts the target resource access records of each of the accounts from the log data in the following manner:
extracting original resource access records of each of the accounts from the log data;
for each of the original resource access records, performing structuring on the original resource access record; performing standardization processing on a resource access record obtained after structuring; and
performing deduplication processing on the resource access records obtained after standardization processing to obtain the target resource access records of the plurality of accounts.

According to one or more embodiments of the present disclosure, Example 9 provides the method of any one of Examples 1 to 8. The method further includes:
for each of the accounts, determining a target type of a permission file corresponding to the account based on a namespace access condition of the account; and
generating, based on the permission configuration information of the account category to which the account belongs and the target type, the permission file corresponding to the account.

According to one or more embodiments of the present disclosure, Example 10 provides the method of any one of Examples 1 to 8. The method further includes:
for each of a plurality of preset permissions, screening, from the plurality of accounts based on the permission data of the plurality of accounts, a plurality of target accounts having the preset permission;
clustering the plurality of target accounts based on the permission data of the plurality of target accounts; and
combining permission data of the target accounts in a target account category to obtain a permission configuration template corresponding to the preset permission, wherein the target account category is an account category that contains a largest number of the target accounts in a clustering result of the plurality of target accounts.

According to one or more embodiments of the present disclosure, Example 11 provides the method of Example 10. The method further includes:
in response to detecting a creation request for a new account, determining, from the plurality of preset permissions, a target permission that matches the creation request; and
generating a permission file of the new account based on the permission configuration template corresponding to the target permission.

According to one or more embodiments of the present disclosure, Example 12 provides an apparatus of permission managing, including:
an obtaining module, configured to obtain permission data of a plurality of accounts in a service system;
a first clustering module, configured to cluster the plurality of accounts based on the permission data of the plurality of accounts; and
a first generation module, configured to generate permission configuration information of at least one account category for the service system based on a clustering result of the plurality of accounts.

According to one or more embodiments of the present disclosure, Example 13 provides a non-transitory computer-readable storage medium having stored thereon a computer program that, when executed by a processing apparatus, causes the method of permission managing according to any one of Examples 1 to 11 to be implemented.

According to one or more embodiments of the present disclosure, Example 14 provides an electronic device, including:
a storage apparatus having a computer program stored thereon; and
a processing apparatus configured to execute the computer program in the storage apparatus to implement the method of permission managing according to any one of Examples 1 to 11.

The foregoing descriptions are merely preferred embodiments of the present disclosure and explanations of the applied technical principles. Those skilled in the art should understand that the scope of disclosure involved in the present disclosure is not limited to the technical solutions formed by the specific combination of the foregoing technical features, and shall also cover other technical solutions formed by any combination of the foregoing technical features or their equivalent features without departing from the foregoing concept of disclosure. For example, a technical solution formed by replacing the foregoing features with technical features with similar functions disclosed in the present disclosure.

In addition, although the operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims. With respect to the apparatus in the foregoing embodiments, a specific manner in which the various modules perform operations has been described in detail in the embodiments related to the method, and will not be described in detail herein.

1. A method of permission managing method, comprising:
obtaining permission data of a plurality of accounts in a service system;
clustering the plurality of accounts based on the permission data of the plurality of accounts; and
generating permission configuration information of at least one account category for the service system based on a clustering result of the plurality of accounts.

2. The method according to claim 1, wherein the clustering the plurality of accounts based on the permission data of the plurality of accounts comprises:
generating, for each of the plurality of accounts, a permission graph corresponding to the account based on permission data of the account; and
clustering the plurality of accounts based on the permission graphs respectively corresponding to the plurality of accounts.

3. The method according to claim 2, wherein the clustering the plurality of accounts based on the permission graphs respectively corresponding to the plurality of accounts comprises:
determining, based on the permission graphs respectively corresponding to the plurality of accounts, a similarity between every two accounts in the plurality of accounts; and
clustering the plurality of accounts based on all the similarities.

4. The method according to claim 3, wherein the determining, based on the permission graphs respectively corresponding to the plurality of accounts, a similarity between every two accounts in the plurality of accounts comprises:
determining a feature vector of the permission graph corresponding to each of the accounts; and
determining, for every two accounts in the plurality of accounts, a similarity between the feature vectors of the permission graphs respectively corresponding to the two accounts as a similarity between the two accounts.

5. The method according to claim 1, wherein the clustering result of the plurality of accounts comprises at least one account category, wherein each of the at least one account category comprises at least one of the accounts; and
the generating permission configuration information of at least one account category for the service system based on a clustering result of the plurality of accounts comprises:
for each of the at least one account category, combining permission data of the accounts in the account category to obtain permission configuration information of the account category.

6. The method according to claim 1, wherein the obtaining permission data of a plurality of accounts in a service system comprises:
obtaining target resource access records of the plurality of accounts in the service system from a first buffer, wherein log data of the service system is synchronously collected by a plurality of distributed clients, the plurality of distributed clients respectively extract the target resource access records of the accounts from the log data respectively collected by the distributed clients and store the target resource access records in local buffers, and the target resource access records in the local buffers are synchronized to the first buffer periodically; and
generating, for each of the accounts, permission data of the account based on the target resource access record of the account.

7. The method according to claim 6, wherein the log data is stored in a second buffer, and the plurality of distributed clients respectively collect the log data from the second buffer.

8. The method according to claim 6, wherein extracting, by the distributed client, the target resource access records of the accounts from the log data comprises:
extracting original resource access records of the accounts from the log data;
performing, for each of the original resource access records, structuring on the original resource access record; and performing standardization processing on a resource access record obtained after structuring; and
performing deduplication processing on the resource access records obtained after standardization processing to obtain the target resource access records of the plurality of accounts.

9. The method according to claim 1, further comprising:
determining, for each of the accounts, a target type of a permission file corresponding to the account based on a namespace access condition of the account; and
generating, based on the permission configuration information of the account category to which the account belongs and the target type, the permission file corresponding to the account.

10. The method according to claim 1, further comprising:
for each of a plurality of preset permissions, screening, from the plurality of accounts based on the permission data of the plurality of accounts, a plurality of target accounts having the preset permission;
clustering the plurality of target accounts based on the permission data of the plurality of target accounts; and
combining permission data of the target accounts in a target account category to obtain a permission configuration template corresponding to the preset permission, wherein the target account category is an account category that contains a largest number of the target accounts in a clustering result of the plurality of target accounts.

11. The method according to claim 10, further comprising:
in response to detecting a creation request for a new account, determining, from the plurality of preset permissions, a target permission that matches the creation request; and
generating a permission file of the new account based on the permission configuration template corresponding to the target permission.

12. The method according to claim 2, further comprising:
determining, for each of the accounts, a target type of a permission file corresponding to the account based on a namespace access condition of the account; and
generating, based on the permission configuration information of the account category to which the account belongs and the target type, the permission file corresponding to the account.

13. The method according to claim 3, further comprising:
determining, for each of the accounts, a target type of a permission file corresponding to the account based on a namespace access condition of the account; and
generating, based on the permission configuration information of the account category to which the account belongs and the target type, the permission file corresponding to the account.

14. The method according to claim 4, further comprising:
determining, for each of the accounts, a target type of a permission file corresponding to the account based on a namespace access condition of the account; and
generating, based on the permission configuration information of the account category to which the account belongs and the target type, the permission file corresponding to the account.

15. The method according to claim 5, further comprising:
determining, for each of the accounts, a target type of a permission file corresponding to the account based on a namespace access condition of the account; and
generating, based on the permission configuration information of the account category to which the account belongs and the target type, the permission file corresponding to the account.

16. The method according to claim 6, further comprising:
determining, for each of the accounts, a target type of a permission file corresponding to the account based on a namespace access condition of the account; and
generating, based on the permission configuration information of the account category to which the account belongs and the target type, the permission file corresponding to the account.

17. The method according to claim 7, further comprising:
determining, for each of the accounts, a target type of a permission file corresponding to the account based on a namespace access condition of the account; and
generating, based on the permission configuration information of the account category to which the account belongs and the target type, the permission file corresponding to the account.

18. The method according to claim 8, further comprising:
determining, for each of the accounts, a target type of a permission file corresponding to the account based on a namespace access condition of the account; and
generating, based on the permission configuration information of the account category to which the account belongs and the target type, the permission file corresponding to the account.

19. A non-transitory computer-readable storage medium having a computer program stored thereon, wherein when the program is executed by a processing apparatus, a method of permission managing method is implemented and the method comprises:
obtaining permission data of a plurality of accounts in a service system;
clustering the plurality of accounts based on the permission data of the plurality of accounts; and
generating permission configuration information of at least one account category for the service system based on a clustering result of the plurality of accounts.

20. An electronic device, comprising:
a storage apparatus having a computer program stored thereon; and
a processing apparatus configured to execute the computer program in the storage apparatus to implement a method of permission managing method is implemented and the method comprises:
obtaining permission data of a plurality of accounts in a service system;
clustering the plurality of accounts based on the permission data of the plurality of accounts; and
generating permission configuration information of at least one account category for the service system based on a clustering result of the plurality of accounts.
